(19) United States
(12) Patent Application Publication
(10) Pub. No.: US 2007/0169109 A1
(43) Pub. Date: Jul. 19, 2007

(54) Method for the installation and configuration of software components

(76) Inventor: Peter Neswal, Strasshof an der Nordbahn (AT)

Correspondence Address: HOFFMANN & BARON, LLP, 6900 JERICHO TURNPIKE, SYOSSET, NY, 11791, US

(21) Appl. No.: 10/580,441

(22) PCT Filed: Nov. 19, 2004
(86) PCT No.: PCT/AT04/00408

§ 371 Date: May 22, 2006

(30) Foreign Application Priority Data
Nov. 21, 2003 (EP) 03450257.5

(51) Int. Cl. G06F 9/445

(52) U.S. Cl. 717/174

(57) ABSTRACT

The invention relates to a method, rule package (RP), framework (FW) and client program (KP) for the automatic installation and configuration of software components (SW) in a computer network (1), which comprises a plurality of client computers (2) and at least one network resource (RES) of installable software components (SW), wherein successful installation of a software component (SW) may have as a prerequisite the presence or absence of another software component (SW), and to correspondingly programmed computers and data storage media. In particular, each rule package (RP) comprises at least one of the following four routines: a routine (4) for installing the software component (SW) on the client computer (2), a routine (4′) for deinstalling said software, a routine (5) for configuring the installed software component (SW), and a routine (5′) for undoing (deconfiguring) the configuration thereof, wherein the rule packages (RP) are run on the client computer (2), calling their installation routines (4) and then their configuration routines (5) and running is triggered by a local event (16-19) on the particular client computer (2).

The present invention relates to a method for the automatic installation and configuration of software components in a computer network which comprises a plurality of client computers and at least one network resource of installable software components. The invention furthermore relates to computer program objects for carrying out this method in the form of a rule package, a framework and a client program, and to computers and data storage media which are programmed with such program objects.

The distribution, installation and configuration of software components in relatively large computer networks, for example corporate networks with thousands of different client computers running hundreds of software components, some of which are moreover to be differently configured, is in practice a non-trivial problem.

The most varied mechanisms have been proposed for solving this problem, see in particular:
“Software Distributor Administration Guide for HP-UX 11i, Edition 3”, Hewlett-Packard Company, June 2002, http://docs.hp.com/hpux/pdf/B2355-90754.pdf;
Bailey, E. C.: “Maximum RPM—Taking the Red Hat Package Manager to the Limit”, Red Hat Software, Inc., June 1998, http://www.rpm.org/local/maximum-rpm.ps.gz;
Jackson, I., et al.: “Debian Packaging Manual, Version 3.2.1.0”, 24 Aug. 2000, http://www.sylence.net/stuff/Debian Packaging Manual.pdf; and furthermore:
Franken, K.: “Using RPM-SuperVisor, v1.11”, 6 Nov. 2001, http://www.klaus.franken.de/rpmsv/download/rpmsv.pdf;
“Safe Mechanism for Installing Operation System Updates with Applications”, IBM Technical Disclosure Bulletin, IBM Corp. N.Y., US, vol. 41, no. 1, 1998, pages 557-559, ISSN: 0018-8689;
“Windows Installer Service Overview”, Microsoft Corporation, 1999, http://download.microsoft.com/download/f/7/7/f777da84-82d-4b90-a597-e329e09032b0/WIS-Pro.doc.
   In all known solutions, installation of the software components on the client computers is always initiated from a central network resource. To this end, in the simplest case, the software components, possibly together with assigned rule packages, which contain instructions for the installation of the particular software component(s), are sent to the client computer (central “push” distribution of software), which occupies high levels of network bandwidth, even if individual software components are not actually required on certain client computers. Improved solutions distribute in a first step update lists with references to software components to be retrieved from the central network resource to the client computer or provide such lists for retrieval (central update lists, “push” or “pull” distribution); the software components, optionally together with or integrated into rule packages for the installation thereof, are then again sent to the client computer.

Both known systems have major disadvantages. In the first case, it is necessary to have precise knowledge regarding the equipment and requirements profile for all client computers in the field, which entails compiling and administering comprehensive directories and distribution keys. The second case also involves a central distribution strategy which cannot respond to rapid in situ changes to the client computer's hardware or software, such as the connection of new hardware, logging onto a network, logging on of a user etc. which, under certain circumstances, may entail not only reinstallation, but also reconfiguration of software components.

The invention is based on the recognition that it would be desirable to provide a solution for the installation and configuration of software components in a computer network of many different client computers, which solution is capable of responding and reacting to individual requirements and current changes of state of each individual client computer.

Said object is achieved in a first aspect with a method of the above-stated kind which is distinguished according to the invention by the steps:

a) provision of a framework on the network resource which comprises a rule package for each of the installable software components of the network resource and a list of rule packages to be run, but not the software components themselves,

wherein at least one of the rule packages comprises a routine for loading its software component from the network resource and installing it on a client computer and at least this or one of the other rule packages comprises a routine for configuring its software component installed on a client computer,

b) transferring the entire framework to a client computer; and

c) running the list of rule packages with installation routines to be run on the client computer, calling their installation routines, and again running the list of rule packages with configuration routines to be run on the client computer, calling their configuration routines,

wherein at least step c) is triggered by a local event on the particular client computer, preferably by a system startup or shutdown, system lock or share, user logon or logoff, network logon or logoff, program startup or shutdown, connection or disconnection of hardware or by a timer.

In this way, it is for the first time possible to achieve fully automatic, decentralised and dynamic self installation and configuration of each individual client computer in a manner which is capable of responding rapidly to local events. Since the entire framework with all potentially necessary rule packages is always available to each client computer, local events and changes of state of the client computer may be directly converted into corresponding software component installation or configuration operations, each client computer being autonomous to the greatest possible extent.

Using the method of the invention it is for the first time possible not only to distribute and install of software components, but simultaneously also to configure them, i.e. to set specific parameters of the installed software component. As a result, user-specific, application environment-specific, group-specific or alternatively simply standard corporate configurations can be implemented on all client computers in the network. All that is required for this purpose is a one-off definition of a rule package for each software component.

This is also the first time that the problem has been recognised and taken into account that correct configuration of the individual software components is only possible once the installation of all software components is complete, as installation operations often have the side-effect of overwriting the configuration of underlying software components. Because all the installation routines are initially run in a first pass and then all the configuration routines are run in a second pass, correct configuration of all the software components is ensured.

One particularly preferred embodiment of the method according to the invention, in which successful installation of a software component on a client computer may have as a prerequisite the presence or absence, configuration or deconfiguration of another software component, is distinguished

in that, in step a), the framework comprises a detector for each possible prerequisite and at least one of the rule packages comprises a routine for deinstalling its software component from a client computer and at least this or one of the other rule packages comprises a routine for undoing (deconfiguring) the configuration of its software component on a client computer, and,

in that, in step c), if in the course of a rule package it is established by means of a detector that the presence or absence, configuration or deconfiguration of another software component is necessary, the installation or deinstallation routine, configuration or deconfiguration routine of the rule package assigned to this other software component is called.

In this way, autonomous rule packages are created which are exclusively referenced by their interdependencies. The framework provides reusable detectors for this purpose, by means of which the prerequisites for installation or configuration of a software component on the client computer may rapidly be verified. On the one hand, this facilitates definition of the rule packages for provision of the framework, on the other hand, the rule packages need only be run one after the other on the client computer, it also being possible for them to call one another in accordance with their dependencies. Each rule package itself “knows” how it can install, deinstall, configure or deconfigure its assigned software component. There is no need to produce specific installation or configuration scripts for the individual client computers.

A further preferred embodiment of the method of the invention is distinguished in that the framework also comprises detectors for a client computer's hardware or operating system and, in the course of a routine, it is verified by means of such a detector whether the client computer is suitable for the particular installation, deinstallation, configuration or deconfiguration of the software component, and/or that, in the course of a routine, it is checked in advance whether the particular installation, deinstallation, configuration or deconfiguration of the software component has already taken place on the client computer and, if so, the routine is immediately terminated.

As a consequence, each rule package becomes still more autonomous, i.e. it also “knows” whether it is relevant or applicable to the particular client computer. Running the rule packages on the client computers consequently becomes still more straightforward. In the most general case, all the rule packages present in the framework may for example simply be run, starting with the first, and each rule package decides for itself whether it need be executed at all or whether it should call other prerequisite rule packages.

Step b) and/or step c) may preferably also be triggered by a remote event on the network resource, for example the transmission of a group or broadcast message etc., by which means the method according to the invention can reproduce the behaviour of conventional central distribution methods.

The invention also extends to a computer program which implements the method according to the invention.

One further aspect of the invention consists in the creation of a rule package as defined in claims 7 to 12 which is executable on an operating system of a client computer. Reference is made to the above explanations relating to the method with regard to the features and advantages of the rule package according to the invention.

A preferred embodiment of a rule package of the invention is distinguished in that it contains at least one trigger reference to a local event on the client computer or a remote event on the network resource, wherein the trigger reference assigns at least one of the routines of the rule package to this event. As a consequence, individual rule packages or their routines may also be executed in event-controlled manner, so substantially increasing the flexibility and responsiveness of the system.

In practice, new software components are constantly appearing on the market. If no special measures are taken, the number of rule packages in the framework would constantly increase; on the other hand, rule packages in the framework become obsolete, for example when software components are withdrawn from service. Such obsolete rule packages are conveniently removed from the framework, but they may still be required on individual client computers, for example due to outdated hardware components. It is thus particularly favourable if rule packages can also be put in an inactive state in which only their deinstallation routine can be called. In this way, the installation of outdated software components can be prevented, while their deinstallation is possible at any time.

The invention also extends to a computer which is programmed with at least one rule package according to the invention.

One further aspect of the invention is a framework as defined in claims 14 and 15 which may be provided on a network resource in a computer network for a plurality of client computers and which contains rule packages according to the invention. Reference is made to the above explanations relating to the method with regard to the features and advantages of the framework.

The invention also extends to a computer and a machine-readable data storage medium which are programmed with a framework according to the invention.

Still one further aspect of the invention consists in the creation of a client program as defined in claims 18 to 23 which is executable on a client computer and contains a framework according to the invention. Reference is made to the above explanations relating to the method with regard to the features and advantages of the client program.

According to a preferred embodiment, the client program comprises a local database which contains a list of rule packages with installation routines which have run successfully and a list of rule packages with configuration routines which have run successfully. Running of the rule packages may be accelerated with the assistance of this database, since, for example for those software packages which have already been installed or configured, the corresponding rule packages need not be called.

This furthermore makes it possible for the client program to compare the rule packages entered in the lists with the rule packages contained in the framework and, for those rule packages which do not appear in the framework, to run their deconfiguration routines in a first pass and their deinstallation routines in a second pass, whereby obsolete or outdated software components may automatically be removed.

According to a preferred embodiment of a client program which makes use of rule packages with trigger references for event-controlled execution, the client program monitors the occurrence of a local event on the client computer, particularly preferably a system startup or shutdown, system lock or share, user logon or logoff, network logon or logoff, program startup or shutdown, connection or disconnection of hardware or response of a timer, and/or the occurrence of a remote event on the network resource, particularly preferably the transmission of a group or broadcast message, and calls the corresponding rule package routine which is assigned via the trigger reference to said event. This may conveniently also proceed with the assistance of the lists in the database, into which the trigger references of the rule packages may also be entered. In this way, individual rule packages or groups of rule packages or their routines may be executed in event-controlled manner.

In any event, it is particularly favourable for the client program to comprise a transaction system for each system-modifying component, in particular for the rule packages. As a result, the system can be rolled back at any time, if for example an installation or configuration fails, as is known in the art. The operating reliability of the client program is substantially increased as a consequence.

Finally, the invention also extends to a computer which is programmed with a client program according to the invention.

The invention will be explained below with reference to exemplary embodiments shown in the drawings, in which:

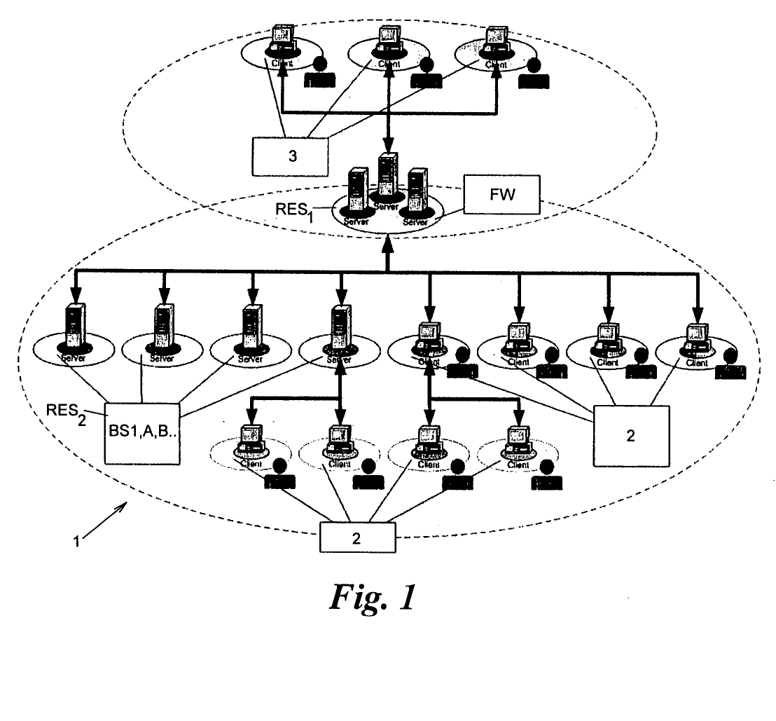

FIG. 1 is a block diagram of a computer network in which the method, the program objects and computers of the invention are used,

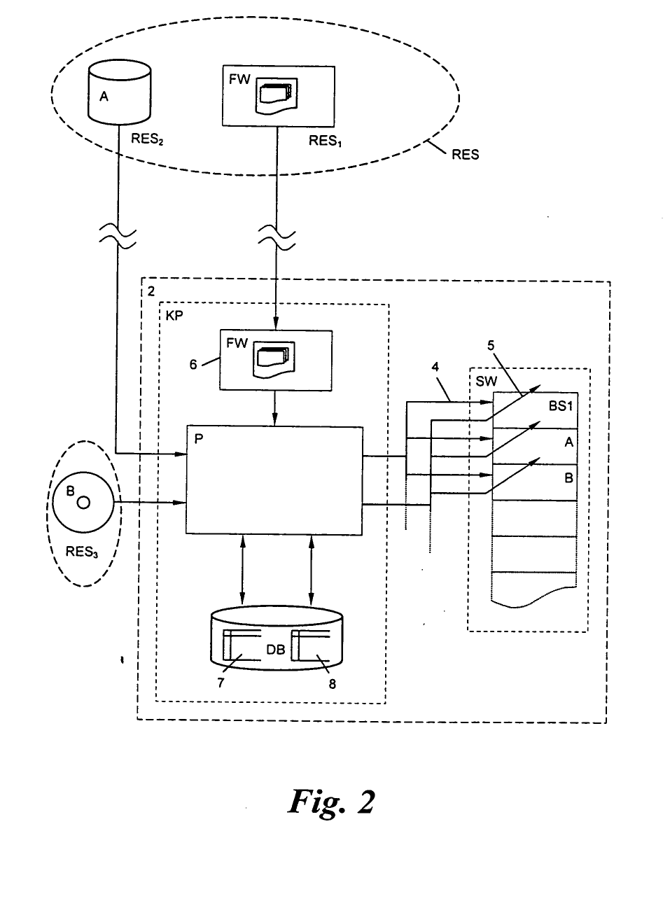

FIG. 2 is a block diagram of an example client computer of the invention programmed with a client program,

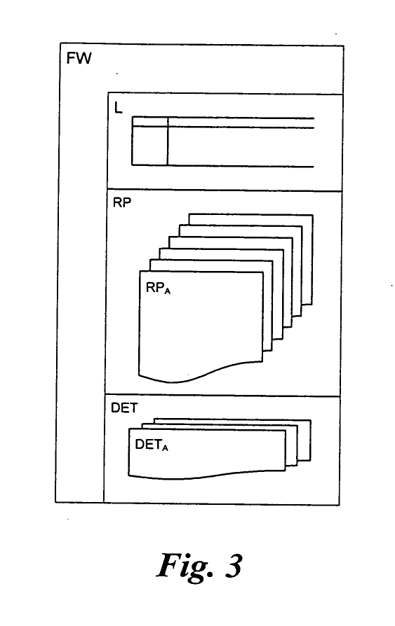

FIG. 3 shows the schematic structure of a framework of the invention,

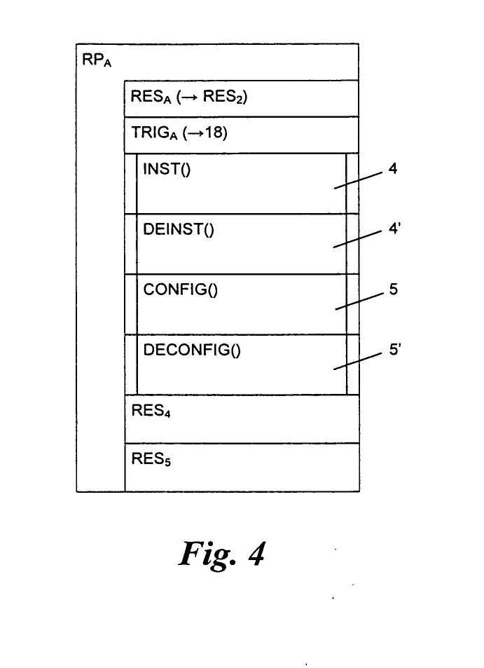

FIG. 4 shows the schematic structure of a rule package of the invention,

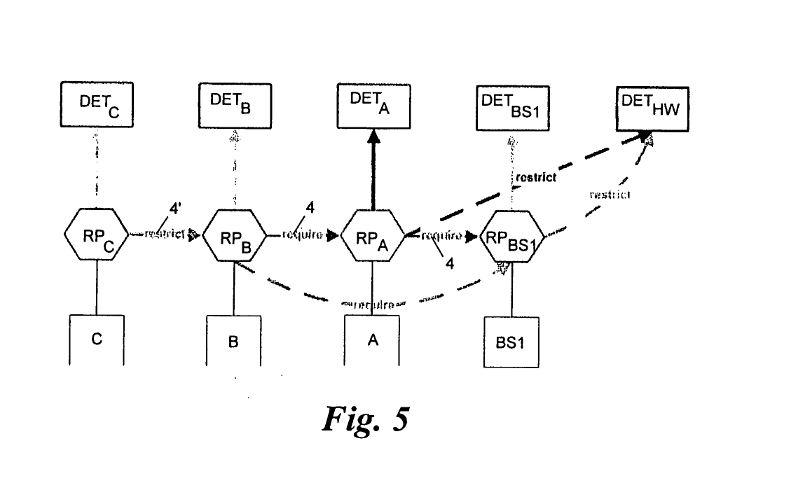

FIG. 5 shows the interrelationships of several example rule packages in the form of a relationship diagram,

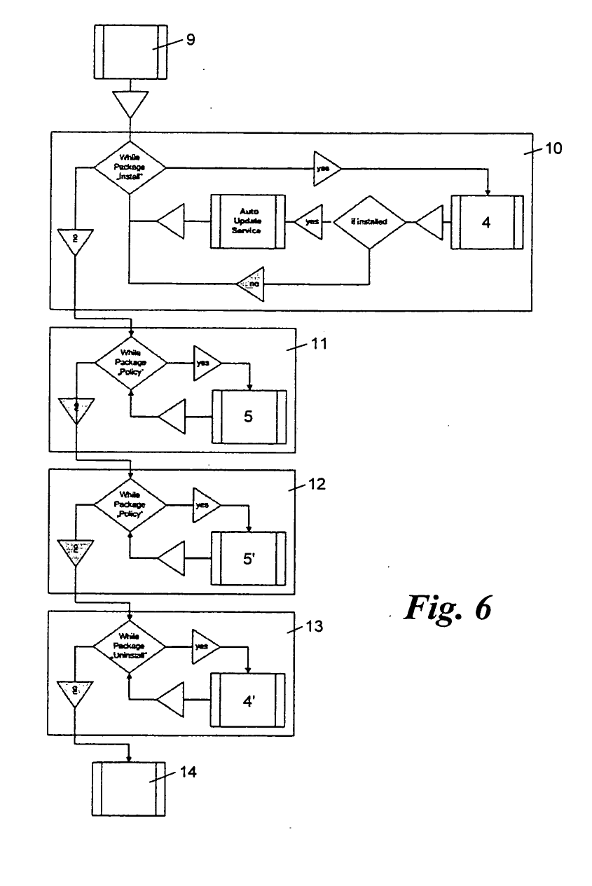

FIG. 6 shows a flow chart of the method of the invention,

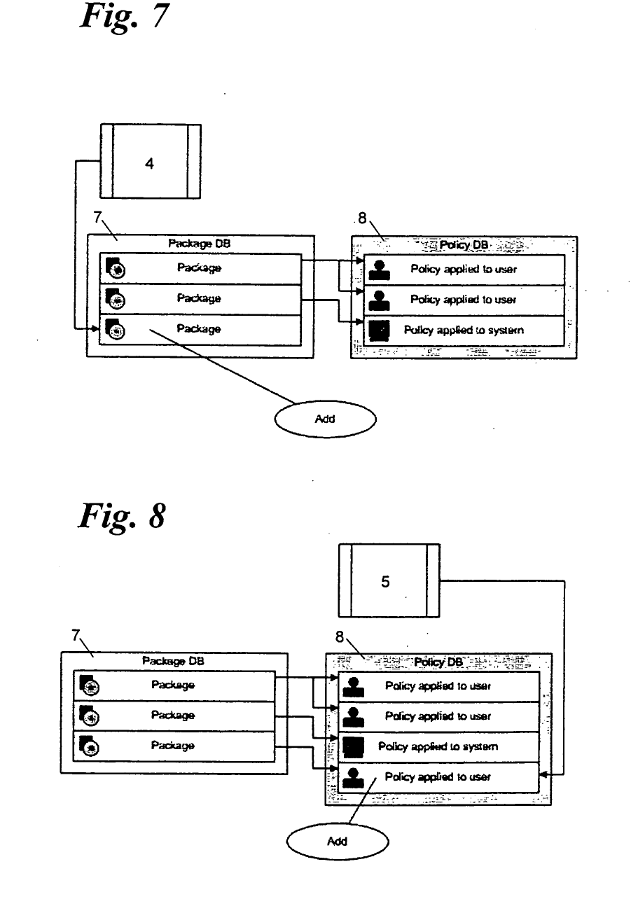

FIG. 7 shows an example of the entries in the local database generated by an installation routine,

FIG. 8 shows an example of entries in the local database generated by a configuration routine,

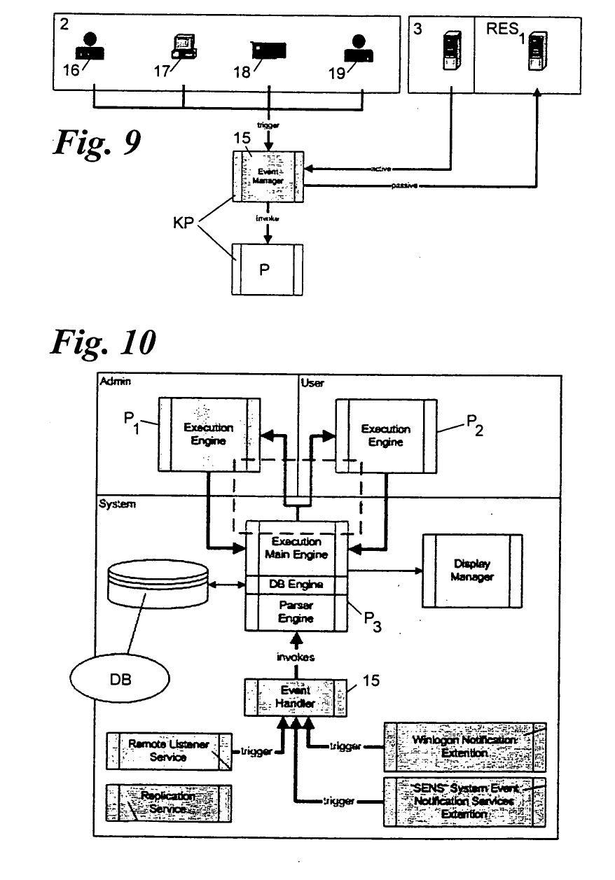

FIG. 9 shows several possible types of triggering for the steps of the method of the invention running on the client computer in the form of a flow chart, and

FIG. 10 shows the block diagram of a possible implementation of the client program on an operating system with execution layers isolated from one another.

FIG. 1 shows a computer network 1 which comprises a plurality of client computers 2. An example client computer 2 is shown in detail in FIG. 2 and contains a number of schematically represented software components BS1, A, B, etc., which, depending on the area of use of the client computer 2, are to be installed and configured in computer-, user- or application-specific manner.

The complete set of all software components which are potentially installable on the client computer 2 is denoted SW in FIG. 2. It must be borne in mind here that the installation and configuration of the software components SW may be subject to complex interdependencies. For example, the installation of software component B requires prior installation of software component A and this in turn requires prior installation of software component BS1, which may, for example, already be installed on the client computer 2 because it is part of the operating system. On the other hand, there may be software components which absolutely require the absence, i.e. deinstallation, of another software component in order to be correctly installed. Such a situation is shown in FIG. 5 (which will be discussed in greater detail below), wherein the paths between software components marked “restrict” indicate that absence of a software component is a prerequisite, while those marked “require” indicate that the presence of a software component is a prerequisite.

It will be understood that the term “software component”, as used here, depending on the particular case and requirements, comprises any kind of granularity or “grain size” of software, whether a driver, a subprogram, a program object, a main program, a subclass or main class, an application, or application complex. This reveals the power of the solution presented here: a rule package RP₁ for the generally known software component “Microsoft Office XP with Microsoft Frontpage, without network support” may, for example, be defined and at the same time a further rule package RP₂ for the partially overlapping, partially subordinate software component “Microsoft Frontpage, with network support”.

To return to FIG. 1, the entire relation system of all software components SW which may potentially be installed on the client computers 2 is shown in the form of a framework FW, the structure of which is explained in greater detail below with reference to FIGS. 3 and 4. The framework FW is provided in the computer network 1 on a network resource RES₁.

Independently of the framework FW, all potentially installable software components SW (BS1, A, B, etc.) are provided in the computer network 1 on a further network resource RES₂.

It will be understood that the network resources RES₁ and RES₂ may also be one and the same network resource RES (see for example FIG. 2) or may themselves be divided into geographically distributed network resources (see for example the distribution of software components A and B among the network resources RES₂ and RES₃ in FIG. 2). It is also possible for one of the network resources, in particular the one for the software components, actually to be an “offline” data storage medium is, for example a CD-ROM etc., as is indicated by way of example in FIG. 2 for software component B.

The framework FW is developed and maintained, i.e. introduced into the network resource RES₁, at administrator workstations 3. Distribution or propagation of the framework FW in the computer network 1 down to the client computers 2 may proceed in any desired manner, for example using “push” methods, such as broadcast or group messages using the Internet protocol, or “pull” methods, such as retrieval by the client computer 2 from logon shares on the network resources at system startup or user logon, by peer-to-peer propagation or replication methods etc.

For example, the framework FW may be replicated by mirroring and so distributed in the manner of Internet Domain Name Services from network node, such as the network resource RES₁, to network node, such as the network resource RES₂. In this manner, the framework FW may also be available on network resources RES₂, the purpose of which is to provide software components SW, or also be replicated directly from client computer 2 to client computer 2 (“peer-to-peer”) . In order to keep network traffic at as low a level as possible during distribution of the framework FW, it is also possible to provide that, after an initial distribution of the entire framework FW, only differential updates of the framework FW to its latest version are subsequently distributed.

The further description of the invention assumes a state in which the framework FW is available to the representatively described client computer 2.

The structure of the framework FW is explained in greater detail with reference to FIGS. 3 and 4. According to FIG. 3, the framework FW comprises a set of rule packages RP, specifically one rule package RP for each software component BS1, A, B, etc. which is potentially installable and/or configurable on a client computer 2. Each rule package RP is a representation of the hard—and software requirements of one particular software component.

FIG. 4 shows the structure of an example rule package RP_{A} for software component A. The rule package RP_{A} contains a reference RES_{A} to its assigned software component A, for example in the form of a pointer to the particular network resource RES₂ on which the software component A is available.

According to FIG. 4, each rule package RP comprises a routine “INST( )” 4 for installing the software component assigned to it (in this case A) on the client computer 2, a further routine “DEINST( )” 4′ for deinstalling this software component from the client computer 2, a routine “CONFIG( )” 5 for configuring this software component and a routine “DECONFIG( )” 5′ for undoing (“deconfiguring”) the configuration of this software component.

A rule package RP need not contain all four routines 4, 4′, 5, 5′, but must contain at least one of the routines 4, 4′, 5, 5′. The rule package RP preferably contains at least one complementary pair of routines 4/4′ or 5/5′, such that in each case it contains the assigned deinstallation or deconfiguration routine 4′, 5′ for the installation or configuration routine 4, 5.

It will be understood that the four routines 4, 4′, 5 and 5′, where they have common portions of code, may also in part be combined to form a common routine, for example a commonly run introductory routine of the rule package RP, or may overall be implemented by a common portion of code which is controlled by appropriate call switches, on one occasion for example functioning as the installation routine 4, on another occasion for example functioning as the deconfiguration routine 5′, etc. In this respect, routines 4, 4′, 5, 5′are “functional” routines, not necessarily routines in the software engineering sense, as is clear to the person skilled in the art.

In the present description, the term “installation” is used to denote the fundamental provision of the possibility of using a software component on a client computer. Installation generally includes storage of the software component A on a local data storage medium (for example the hard disk) of the client computer, and frequently also an initial, general configuration (see below) of the software component to ensure that it is fundamentally operable. Installation may also include one or more rules for automatically supplementing or modifying the stored software component A by means of provided updates.

The term “deinstallation” is used to denote the removal of the software component SW from the client computer 2, for example by deletion from the hard disk.

The term “configuration” is in turn used to denote any kind of standard, group-specific, user-specific or application-specific setting of a software component, as symbolised by the setting arrow in FIG. 2. The method according to the invention thus not only enables the autonomous installation of all necessary software components on a client computer, but also the setting of a specific state, defined in the framework FW, of these software components.

In the present description, the phrase “undoing a configuration” or “deconfiguring” is taken to mean the recreation of the particular setting of a software component as prevailed before the configuration, and/or setting the other software components remaining behind after deinstallation of this software component in a manner which is required for the current system state without the deinstalled software component; the latter is also the intended meaning of the phrase undoing the configuration “with regard to” this software component.

According to FIG. 4, the rule package RP_{A} may optionally contain one or more trigger references TRIG_{A} to a local or remote event, on the occurrence of which at least one of its routines 4, 4′, 5, 5′ should be executed, as is explained in greater detail below with reference to FIG. 9.

The rule package RP_{A} may also comprise local resources RES₄, RES₅ for example small software components or configuration parameters.

Each of routines 4, 4′, 5, 5′ contains an independent verification of the prerequisites for the installation, configuration, deinstallation or deconfiguration of the software component assigned to the rule package, for example the requirement for the presence of another software component (“require” paths in FIG. 5) or the absence of a component (“restrict” paths in FIG. 5). If the particular routine establishes a presence requirement (“require”), it calls the installation routine 4 of the other rule package RP assigned to this other software component; if it establishes an absence requirement (“restrict”), it calls its deinstallation routine 4′. In this way, the interrelationships of FIG. 5 are maintained and executed by running the rule packages. Obviously, this verification may also be relocated to a part of the rule package which is common to the routines and which is always run on execution of a routine.

In order to simplify the verification of the presence or absence of a specific software component, the framework FW comprises a set of detection routines or detectors DET, for example a detector DET_{A} for the presence of the software component A, a detector DET_{BS1} for the presence of the operating system component BS1 or a detector DET_{HW} for the presence of specific hardware on the specific client computer 2, see FIG. 5.

The detectors DET may not only verify the presence or absence of a software component SW, but also whether a software component is currently running or being executed or not. In the present description, all these variants are jointly denoted by the phrase “presence or absence” or are one of the possible prerequisites for a software component which a detector DET can verify.

The detectors DET may also call one another or make use of one another, for example if a prerequisite to be verified may be broken down into a plurality of individual prerequisites, for which other detectors are already present.

Appendix 1 shows an example of implementation of a detector for establishing the presence of the software component “Microsoft Word 10.0” from Microsoft. The “query_exist” subroutine verifies the presence of the software component; the “query_active” subroutine verifies whether the software is running.

Each of routines 4, 4′, 5, 5′ may advantageously be designed such that it itself verifies or verifies by means of corresponding detectors DET whether it is suitable for the hardware or software found on the client computer 2 and, if not, is for example terminated without further action, i.e. returns control. The routine may also verify whether the called installation, deinstallation, configuration or deconfiguration of its software component has not already occurred, in which case it is likewise terminated, i.e. returns control. Alternatively, these checks may however also be relocated to a portion of code of the rule package RP which is common to the routines (see above) or to the calling process P (see below).

Finally, the framework FW comprises a list L of those rule packages RP which should be run first in the client computer 2. It will be understood that the list L may, for example, refer only to the first rule package RP, which recurses into further rule packages RP, or may simply list all rule packages RP, if the latter in each case themselves establish the prerequisites for their execution, or may alternatively list only those rule packages which are specified by an administrator as a “thought for the day” etc.

In a preferred implementation, a rule package RP consists of a set of files which are referenced by a central rule package specification file. An example of such a rule package specification file is shown in Appendix 2. The reference to the software component can be seen in the header portion of the file; the references “install”, “uninstall”, “policies_true” and “policies_false” point respectively to the four routines 4, 4′, 5 and 5′.

Evaluation of the framework FW and running of the rule packages RP on the client computer 2 is carried out with the assistance of a client program KP, which carries out the described running of the list L in a process P (FIG. 2). To this end, the client program KP contains a storage means S for local storage of a copy of the framework FW, which may also be used for the further distribution (replication) of the framework FW on other client computers 2.

The client program KP further has a local database DB which keeps two lists 7, 8, the of use which is shown in greater detail in FIGS. 7 and 8. The first list 7 contains an entry for each rule package RP whose installation routine 4 has been run successfully. The second list 8 contains an entry for each rule package RP whose configuration routine 5 has been run successfully. The client program KP accordingly has a record of all the software components SW which have been successfully installed and configured on the client computer 2, which record may also be used when running the rule packages RP to identify and avoid double calls or endless recursions. The local database DB is also of use in identifying and removing obsolete or outdated software components, as is thoroughly explained in the context of the flow chart of FIG. 6.

FIG. 6 shows an example flow chart for the client program KP. After initialisation in block 9, in block 10 all the rule packages RP listed in list L of the framework FW are run, specifically by calling their installation routines 4. It will be understood that if, in so doing, the rule packages RP establish by means of the detectors DET the prerequisite of presence or absence of other rule packages RP, they will in each case recurse into these other rule packages, as already explained.

Once all the installation routines 4 have been run in block 10 and thus all the necessary software components BS1, A, B, etc. have been installed on the client computer 2, the client program KP or its process P passes over to block 11, in which the software packages are configured in a second pass through the list L. In block 11, the rule packages RP listed in list L are run again, but this time calling their configuration routine 5. If necessary, the rule packages RP may again recurse into further rule packages, as already explained.

Because a complete installation of all necessary software components initially proceeds in block 10, it is ensured that configuration in block 11 starts from a defined system state which in many cases is essential for correct configuration.

The further blocks 12 and 13 of the method or of the client program KP shown in FIG. 6 are optional and serve to eliminate obsolete or outdated software components from the client computer 2.

As already mentioned, rule packages RP for obsolete or outdated software components are no longer contained in the framework FW, but may nevertheless still be necessary on a client computer 2, for example due to outdated hardware. The client program KP accordingly compares the rule packages RP contained in the framework FW with the rule packages RP entered in lists 7 and 8 of the local database DB and puts those rule packages RP, which no longer appear in the framework FW, in an inactive state, for example by an appropriate flag in lists 7 and 8 or in the rule package RP itself. When in the inactive state, a rule package RP can only any longer be called by means of its deinstallation routine 4′ or its deconfiguration routine 5′.

In block 12, all inactive rule packages RP are called by means of their deconfiguration routines 5′. In the following block 13, another pass proceeds through their deinstallation routines 4′.

As already explained, each deinstallation or deconfiguration routine (or also the process P) checks whether it is usable on its “target”, the client computer 2, and only if this is possible (for example removal of outdated hardware), is it executed. On deconfiguration or deinstallation, it then also in each case deletes itself again from list 7 or 8 of the local database DB.

In this way, each pass of the client program KP involves execution of a kind of “cleaning” pass which eliminates outdated or obsolete software components and their rule packages.

In block 14 of the flow chart of FIG. 6, completion processes are carried out and the client program KP terminated.

Execution of the client program KP on the client computer 2 may be initiated in many different ways. FIG. 9 shows some possible variants. Upstream from the run process P of the client program KP there is an event manager 15 which can process both local events on the client computer 2 and remote events, for example at the maintenance workstations 3.

Some kinds of local events 2 are represented symbolically, for example user events 16 such as pressing an appropriate key, system events 17 such as identification of a system startup or shutdown, user logon or logoff, network logon or logoff, program startup or shutdown etc., hardware events 18 such as connection or disconnection of hardware, or local events 19 defined by the system administrator. It is, however, also possible for the client program KP to be triggered by remote events, for example by active transmission of a trigger command from a maintenance workstation 3, or by “passive” retrieval of a trigger command from a network resource RES₁, for example in the course of a network logon or at predetermined times of day.

The stated events may also directly trigger the execution of specific rule packages RP or routines 4, 4′, 5, 5′, specifically by means of their trigger references TRIG (see FIG. 4). The event manager 15 of the client program KP may directly call the rule packages or routines assigned via the trigger references TRIG, or via lists 7, 8 of the local database DB, in which the rule packages RP have entered their trigger references TRIG. It is also possible in block 9 of the client program KP, after triggering of the event manager 15, to preselect those rule packages, in accordance with their trigger references TRIG, which correspond to the event trigger of the event manager 15, and then to run the client program 15 only for these preselected rule packages RP.

Another possibility is to use the trigger references TRIG in the rule packages RP as a “filter” for running the rule packages in the course of event-controlled execution of the client program KP: if a rule package contains at least one trigger reference TRIG, when called by the client program KP it is executed only if its trigger reference TRIG also corresponds to this event.

FIG. 10 shows an implementation example of the client program KP in the context of an operating system of a client computer 2, which provides protected domains (“contexts”) for individual processes, for example in order to isolate user processes from system processes and so enhance operating stability. Since software component installation and configuration often require cross-context permissions, the run process P is here subdivided into several execution engines P₁, P₂ and P₃ running in protected system domains “Admin”, “User” and “System”.

For each system-modifying component of the method, for example the routines of the rule packages, it is possible to implement a transaction system which enables complete rollback of the system configuration should the installation, deinstallation, configuration or decohfiguration of a software component fail.

The invention is not limited to the stated embodiments but instead includes all variants and modifications which fall within the scope of the attached claims.

```
APPENDIX 1
[sml::header]
smlversion=3.0.0
encoding=iso-8859-1
type=dsf
objectid=3-A11-100A-57F0-1000C000001-0-0
sqn=3-FFFF-100A-57F0-25-0-0
name=Microsoft Office XP Premium Edition
[dsf::query_exist]
/* detect Office 10.0 components */
if.reg.keyexist condition:true,-
>reghive=HKEY_LOCAL_MACHINE,regpath=SOFTWARE\Microsoft\Office\10.0,
{
  do.reg.setkey
regkeyhandle:hRegistry,reghive=HKEY_LOCAL_MACHINE,regpath=SOFTWARE\Microsoft\Office\10.0\Word
\InstallRoot,option=OPEN,
  if.sys.handleisvalid condition:true regkeyhandle:hRegistry,
  {
    ;detect WinWord
    ;first let's see if the required file exists
    if.file.exist condition:false,->
    .->filepath=<!--get.reg.value regkeyhandle:hRegistry,->regentry=Path,--!>WINWORD.EXE,
    {
      do.sys.exit->level=section,returnvalue=false,
    }
    ;second let's check the files required property
    if.file.matchversionproperty condition:false,->
    .->filepath=<!--get.reg.value regkeyhandle:hRegistry,->regentry=Path,--!>WINWORD.EXE,
    .->propertyname=fileversion, versionproperty type:eq,=10.*,
    {
      do.sys.exit->level=section.returnvalue=false,
    }
    do.sys.closehandle regkeyhandle:hRegistry,
  }
}
[dsf::query_active]
/* dedect if Office 10.0 WinWord component is running */
if.reg.keyexist condition:true-,
>reghive=HKEY_LOCAL_MACHINE,regpath=SOFTWARE\Microsoft\Office\10.0,
{
  do.reg.setkey
regkeyhandle:hRegistry,reghive=HKEY_LOCAL_MACHINE,regpath=SOFTWARE\Microsoft\Office\10.0\Word
\InstallRoot,option=OPEN,
  if.sys.handleisvalid condition:true regkeyhandle:hRegistry,
  {
    ;dedect WinWord
    if.process.exist condition:false,->processname=WINWORD.EXE, module=<!--get.reg.value
regkeyhandle:hRegistry,->regentry=Path.--!>WINWORD.EXE,
    {
      call.sys.exit->level=section,returnvalue=false,
    }
    call.sys.closehandle regkeyhandle:hRegistry,
  }
}
[sml::header]
smlversion=3.0.0
encoding=iso-8859-1
type=psf
objectid=3-3F1-100A-57F0-1000C000001-0-0
sqn=3-FFFF-100A-57F0-2-0-0
name=Microsoft Office XP Premium
[psf::definition]
packagename->text=Microsoft Office XP,
packagedescription->text=The Microsoft Office XP Premium Suite,
packagecompany->text=Microsoft,
packagecopyright->text=Copyright © Microsoft Corporation 1985-2001. All rights reserved.,
packageproductversion->versionnumber=10.0,
packagedate->text=2002-01-01,
[sml::system]
transactioncontext->context=package,
securitycontext->context=ADM,
oscontext->context=Win32,
[sml::ossupport]
windowssys->platform=x86,os=nt,osversion type:==,=5.0,sp type:>=,=3,
windowssys->platform=x86,os=nt,osversion type:==,=5.1,sp type:>=,=1,
winesys->platform=x86,wineversion type:>=,=2.0.0,winetype=CROSSOVER_OFFICE,
[psf::detectself]
detectsoftware->objectid=3-A11-100A-57F0-1000C000001-0-0,
[sml::displaysupport]
display->show=1,
displayheader->text=Microsoft Office XP,
displaytext->text=Manages Microsoft Office XP...,
[psf::archive]
archivepolicies->archive=1,override=1,
archiveuninstall->archive=1,
[psf::installoptions]
rollbackonerror->rollback=1,
installevents->event=ALL,
ownersonly->restrict=0,
[psf::dedecttargets]
if.group.accountismember->groupname groupformat:default, type:eq,=officexp,
[psf::install]
installjobid->objectid=3-411-100A-57F0-1000C000001-0-0,
[psf::uninstall]
uninstalljobid->objectid=3-441-100A-57F0-1000C000001-0-0,
[psf::policies_true]
policyid->objectid=3-471-1000A-57F0-1000C000001-0-0,
[psf::policies_false]
policyid->objectid=3-471-100A-57F0-1000C000002-0-0
```

1. A method for the automatic installation and configuration of software components in a computer network which comprises a plurality of client computers and at least one network resource of installable software components, comprising the steps of:
a) provision of a framework on the network resource which comprises a rule package for each of the installable software components of the network resource and a list of rule packages to be run, but not the software components themselves,
wherein at least one of the rule packages comprises a routine for loading its software component from the network resource and installing it on a client computer and at least this or one of the other rule packages comprises a routine for configuring its software component installed on a client computer,
b) transferring the entire framework to a client computer; and
c) running the list of rule packages with installation routines to be run on the client computer, calling their installation routines, and again running the list of rule packages with configuration routines to be run on the client computer, calling their configuration routines,
wherein at least step c) is triggered by a local event on the particular client computer.

2. A method according to claim 1, wherein step c) is triggered by a system startup or shutdown, system lock or share, user logon or logoff, network logon or logoff, program startup or shutdown, connection or disconnection of hardware or by a timer.

3. A method according to claim 1, in which successful installation of a software component on a client computer may have as a prerequisite the presence or absence, configuration or deconfiguration of another software component, wherein,
in step a), the framework comprises a detector for each possible prerequisite and at least one of the rule packages comprises a routine for deinstalling its software component from a client computer and at least this or one of other rule packages comprises a routine for undoing the configuration of its software component on a client computer, and,
in step c), if in the course of a rule package it is established by means of a detector that the presence or absence, configuration or deconfiguration of another software component is necessary, the installation or deinstallation routine, configuration or deconfiguration routine of the rule package assigned to this other software component is called.

4. A method according to claim 1, wherein the framework also comprises detectors for a client computer's hardware or operating system and, in the course of a routine, it is verified by means of such a detector whether the client computer is suitable for the particular installation, deinstallation, configuration or deconfiguration of the software component.

5. A method according to claim 1, wherein, in the course of a routine, it is checked in advance whether the particular installation, deinstallation, configuration or deconfiguration of the software component has already taken place on the client computer and, if so, the routine is immediately terminated.

6. A method according to claim 1, wherein step b) and/or step c) is also triggered by a remote event on the network resource, preferably the transmission of a group or broadcast message.

7. A rule package which is executable on an operating system of a client computer for the automatic installation and configuration of software components, which are available on a network resource, on the client computer wherein the rule package comprises a reference to a software component on the network resource and comprises at least one of the following four routines: a routine for installing this software component on the client computer, a routine for deinstalling this software component from the client computer, a routine for configuring said software component installed on the client computer, and a routine for undoing the configuration of this software component installed on the client computer, wherein each routine, if it establishes a presence or absence requirement of another software component, branches to the installation or deinstallation routine of another rule package assigned to this other software component.

8. A rule package according to claim 7, wherein it comprises a reference to a client computer's specific hardware and/or operating system and, by means of this reference, verifies whether the client computer is suitable for the particular installation, deinstallation, configuration or deconfiguration of the software component.

9. A rule package according to claim 7, wherein it verifies whether the particular installation, deinstallation, configuration or deconfiguration of the software component on the client computer has already occurred and, if so, terminates its execution.

10. A rule package according to claim 7, wherein it contains at least one trigger reference to a local event on the client computer, wherein the trigger reference assigns at least one of the routines of the rule package to this event.

11. A rule package according to claim 7, wherein it further contains at least one trigger reference to a remote event on the network resource, wherein the trigger reference assigns at least one of the routines of the rule package to this event.

12. A rule package according to claim 7, wherein it may be put in an inactive state in which only its deinstallation and deconfiguration routines can be called.

13. A computer which is programmed with at least one rule package according to claim 7.

14. A framework which may be provided on a network resource in a computer network for a plurality of client computers for the automatic installation and configuration on the client computers of software components available on the network resource, wherein successful installation of a software component may have as a prerequisite the presence or absence of another software component, wherein the framework comprises a set of rule packages according to claim 7, a set of detectors for each possible prerequisite, and a list of rule packages to be run on the client computers.

15. A framework according to claim 14 in conjunction with a rule package that comprises a reference to a client computer's specific hardware and/or operating system and, by means of this reference, verifies whether the client computer is suitable for the particular installation, deinstallation, configuration or deconfiguration of the software component, wherein the framework also comprises detectors for a client computer's hardware or operating system and provides the rule packages for the stated verification.

16. A computer which is programmed with a framework according to claim 14.

17. A machine-readable data storage medium which is programmed with a framework according to claim 14.

18. A client program which is executable on a client computer for the automatic installation and configuration of software components, which are available on a network resource, on the client computer, wherein it receives and stores a framework according to claim 14, in a first pass runs the list of rule packages to be run, calling their installation routines, and in a second pass runs the list of rule packages to be run, calling their configuration routines.

19. A client program according to claim 18, wherein it comprises a local database which contains a list of rule packages with installation routines which have run successfully and a list of rule packages with configuration routines which have run successfully.

20. A client program according to claim 19, wherein it compares the rule packages entered in the lists with the rule packages contained in the framework and, for those rule packages which do not appear in the framework, runs their deconfiguration routines in a first pass and their deinstallation routines in a second pass.

21. A client program according to claim 18, in conjunction with a rule package which is executable on an operating system of a client computer for the automatic installation and configuration of software components, which are available on a network resource, on the client computer, the rule package comprising a reference to a software component on the network resource and comprising at least one of the following four routines: a routine for installing this software component on the client computer, a routine for deinstalling this software component from the client computer, a routine for configuring said software component installed on the client computer, and a routine for undoing the configuration of this software component installed on the client computer, wherein each routine, if it establishes a presence or absence requirement of another software component, branches to the installation or deinstallation routine of another rule package assigned to this other software component, the rule package further containing at least one trigger reference to a local event on the client computer, wherein the trigger reference assigns at least one of the routines of the rule package to this event, wherein the program monitors the occurrence of a local event on the client computer, preferably a system startup or shutdown, system lock or share, user logon or logoff, network logon or logoff, program startup or shutdown, connection or disconnection of hardware or response of a timer, and calls the corresponding rule package routine which is assigned via the trigger reference to said event.

22. A client program according to claim 18, in conjunction with a rule package which is executable on an operating system of a client computer for the automatic installation and configuration of software components, which are available on a network resource. on the client computer, the rule package comprising a reference to a software component on the network resource and comprising at least one of the following four routines: a routine for installing this software component on the client computer, a routine for deinstalling this software component from the client computer, a routine for configuring said software component installed on the client computer, and a routine for undoing the configuration of this software component installed on the client computer, wherein each routine, if it establishes a presence or absence requirement of another software component, branches to the installation or deinstallation routine of another rule package assigned to this other software component, the rule package further containing at least one trigger reference to a remote event on the network resource, wherein the trigger reference assigns at least one of the routines of the rule package to this event, wherein the program further monitors the occurrence of a remote event on the network resource, preferably the transmission of a group or broadcast message, and calls the corresponding rule package routine which is assigned via the trigger reference to this event.

23. A client program according to claim 18, wherein it comprises a transaction system for each system-modifying component, in particular for the rule packages.

24. A computer which is programmed with a client program according to claim 18.

25. A computer program implementing a method according claim 1.
